(19) United States
(12) Patent Application Publication
(10) Pub. No.: US 2010/0210747 A1
(43) Pub. Date: Aug. 19, 2010

(54) COMPOSITIONS AND USE OF TRANS-1,1,1,4,4,4-HEXAFLUORO-2-BUTENE FOAM-FORMING COMPOSITION IN THE PREPARATION OF POLYISOCYANATE-BASED FOAMS

(75) Inventors: Gary Loh, Newark, DE (US); Joseph Anthony Creazzo, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington (DE)

(21) Appl. No.: 12/669,795

(22) PCT Filed: Jul. 17, 2008
(86) PCT No.: PCT/US08/70242

§ 371 Date: Jan. 20, 2010

Related U.S. Application Data
(60) Provisional application No. 60/961,389, filed on Jul. 20, 2007.

(51) Int. Cl. C08G 18/72; C08J 9/14

(52) U.S. Cl. 521/155

(57) ABSTRACT

A foam-forming composition is disclosed which includes both trans-1,1,1,4,4,4-hexafluoro-2-butene and an active hydrogen-containing compound having two or more active hydrogens. Also disclosed is a closed-cell polyurethane or polyisocyanurate polymer foam prepared from reaction of effective amounts of the foam-forming composition and a suitable polyisocyanate. Also disclosed is a process for producing a closed-cell polyurethane or polyisocyanurate polymer foam comprising: reacting an effective amount of the foam-forming composition and a suitable polyisocyanate.

### FIELD OF THE INVENTION

The disclosure herein relates to foam-forming compositions comprising a fluoroolefin blowing agent and an active hydrogen-containing compound, and using such compositions for producing polyurethane and polyisocyanurate foams. More particularly, the disclosure herein relates to foam-forming compositions comprising trans-1,1,1,4,4,4-hexafluoro-2-butene and an active hydrogen-containing compound having two or more active hydrogens, and using such compositions for producing polyurethane and polyisocyanurate foams.

### BACKGROUND OF THE INVENTION

Closed-cell polyisocyanate-based foams are widely used for insulation purposes, for example, in building construction and in the manufacture of energy efficient electrical appliances. In the construction industry, polyurethane/polyisocyanurate board stock is used in roofing and siding for its insulation and load-carrying capabilities. Poured and sprayed polyurethane foams are widely used for a variety of applications including insulating roofs, insulating large structures such as storage tanks, insulating appliances such as refrigerators and freezers, insulating refrigerated trucks and railcars, etc.

All of these various types of polyurethane/polyisocyanurate foams require blowing agents for their manufacture. Insulating foams depend on the use of halocarbon blowing agents, not only to foam the polymer, but primarily for their low vapor thermal conductivity, a very important characteristic for insulation value. Historically, polyurethane foams used CFCs (chlorofluorocarbons, for example CFC-11, trichlorofluoromethane) and HCFCs (hydrochlorofluorocarbons, for example HCFC-141b, 1,1-dichloro-1-fluoroethane) as the primary blowing agent. However, due to the implication of chlorine-containing molecules such as the CFCs and HCFCs in the destruction of stratospheric ozone, the production and use of CFCs and HCFCs has been restricted by the Montreal Protocol. More recently, hydrofluorocarbons (HFCs), which do not contribute to the destruction of stratospheric ozone, have been employed as blowing agents for polyurethane foams. An example of an HFC employed in this application is HFC-245fa (1,1,1,3,3-pentafluoropropane). The HFCs do not contribute to the destruction of stratospheric ozone, but are of concern due to their contribution to the “greenhouse effect”, i.e., they contribute to global warming. As a result of their contribution to global warming, the HFCs have come under scrutiny, and their widespread use may also be limited in the future.

Hydrocarbons have also been proposed as foam blowing agents. However, these compounds are flammable, and many are photochemically reactive, and as a result contribute to the production of ground level ozone (i.e., smog). Such compounds are typically referred to as volatile organic compounds (VOCs), and are subject to environmental regulations.

There is need for producing foams that provide low flammability, good thermal insulation and high dimensional stability by using a blowing agent that has substantially no ozone depletion potential (ODP) and no or very low global warming potential (GWP).

Japanese Patent No. 05179043 discloses the use of cis-1,1,1,4,4,4-hexafluoro-2-butene as the blowing agent together with highly compatible polyether polyols to form polyurethane foams.

There is need for producing polyurethane/polyisocyanurate foams by using trans-1,1,1,4,4,4-hexafluoro-2-butene as the blowing agent.

### SUMMARY OF THE INVENTION

This disclosure provides a foam-forming composition comprising trans-1,1,1,4,4,4-hexafluoro-2-butene and an active hydrogen-containing compound having two or more active hydrogens.

This disclosure also provides a closed-cell polyurethane or polyisocyanurate polymer foam prepared from reaction of effective amounts of the foam-forming composition and a suitable polyisocyanate.

This disclosure also provides a method for producing a closed-cell polyurethane or polyisocyanurate polymer foam. The method comprises reacting an effective amount of the foam-forming composition and a suitable polyisocyanate.

### DETAILED DESCRIPTION

By “cream time”, it is meant to refer to the time period starting from the mixing of the active hydrogen-containing compound with polyisocyanate, and ending at when the foaming starts to occur and color of the mixture starts to change.

By “rise time”, it is meant to refer to the time period starting from the mixing of the active hydrogen-containing compound with polyisocyanate, and ending at when the foam rising stops.

By “tack free time”, it is meant to refer to the time period starting from the mixing of the active hydrogen-containing compound with polyisocyanate, and ending at when the surface of the foam is no longer tacky.

The composition of this disclosure is a foam-forming composition comprising trans-1,1,1,4,4,4-hexafluoro-2-butene and an active hydrogen-containing compound having two or more active hydrogens, in the form of hydroxyl groups. In one embodiment of this invention, the foam-forming composition comprises trans-1,1,1,4,4,4-hexafluoro-2-butene, cis-1,1,1,4,4,4-hexafluoro-2-butene and an active hydrogen-containing compound having two or more active hydrogens, in the form of hydroxyl groups. In this disclosure, trans-1,1,1,4,4,4-hexafluoro-2-butene and cis-1,1,1,4,4,4-hexafluoro-2-butene are used as blowing agents.

Cis-1,1,1,4,4,4-hexafluoro-2-butene is a known compound, and its preparation method has been disclosed, for example, in U.S. Patent Application No. 60/926,293 [FL1346 US PRV] filed Apr. 26, 2007, hereby incorporated by reference in its entirety.

Trans-1,1,1,4,4,4-hexafluoro-2-butene is a known compound, and its preparation method has been disclosed, for example, in U.S. Pat. No. 5,463,150, hereby incorporated by reference in its entirety.

The active hydrogen-containing compounds of this invention can comprise compounds having two or more groups that contain an active hydrogen atom reactive with an isocyanate group, such as described in U.S. Pat. No. 4,394,491; hereby incorporated by reference. Examples of such compounds have at least two hydroxyl groups per molecule, and more specifically comprise polyols, such as polyether or polyester polyols. Examples of such polyols are those which have an equivalent weight of about 50 to about 700, normally of about 70 to about 300, more typically of about 90 to about 270, and carry at least 2 hydroxyl groups, usually 3 to 8 such groups.

Examples of suitable polyols comprise polyester polyols such as aromatic polyester polyols, e.g., those made by transesterifying polyethylene terephthalate (PET) scrap with a glycol such as diethylene glycol, or made by reacting phthalic anhydride with a glycol. The resulting polyester polyols may be reacted further with ethylene—and/or propylene oxide—to form an extended polyester polyol containing additional internal alkyleneoxy groups.

Examples of suitable polyols also comprise polyether polyols such as polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16, generally 3 to 8 hydroxyl groups as present, for example, in glycerol, pentaerythritol and carbohydrates such as sorbitol, glucose, sucrose and the like polyhydroxy compounds. Suitable polyether polyols can also include alaphatic or aromatic amine-based polyols.

The present invention also relates to processes for producing a closed-cell polyurethane or polyisocyanurate polymer foam by reacting an effective amount of the foam-forming compositions with a suitable polyisocyanate.

Typically, before reacting with a suitable polyisocyanate, the active hydrogen-containing compound described hereinabove and optionally other additives are mixed with the blowing agent to form a foam-forming composition. The resulting foam-forming composition is typically known in the art as an isocyanate-reactive preblend, or B-side composition. The foam-forming composition of this invention can be prepared in any manner convenient to one skilled in this art, including simply weighing desired quantities of each component and, thereafter, combining them in an appropriate container at appropriate temperatures and pressures.

When preparing polyisocyanate-based foams, the polyisocyanate reactant is normally selected in such proportion relative to that of the active hydrogen-containing compound that the ratio of the equivalents of isocyanate groups to the equivalents of active hydrogen groups, i.e., the foam index, is from about 0.9 to about 10 and in most cases from about 1 to about 4.

While any suitable polyisocyanate can be employed in the instant process, examples of suitable polyisocyanates useful for making polyisocyanate-based foam comprise at least one of aromatic, aliphatic and cycloaliphatic polyisocyanates, among others. Representative members of these compounds comprise diisocyanates such as meta- or paraphenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate (and isomers), napthylene-1,5-diisocyanate, 1-methylphenyl-2,4-phenyldiisocyanate, diphenylmethane-4,4-diisocyanate, diphenylmethane-2,4-diissocyanate, 4,4-biphenylenediisocyanate and 3,3-dimethyoxy-4,4 biphenylenediisocyanate and 3,3-dimethyldiphenylpropane-4,4-diisocyanate; triisocyanates such as toluene-2,4,6-triisocyanate and polyisocyanates such as 4,4-dimethyldiphenylmethane-2,2,5,5-tetraisocyanate and the diverse polymethylenepoly-phenylopolyisocyanates, mixtures thereof, among others.

A crude polyisocyanate may also be used in the practice of this invention, such as the crude toluene diisocyanate obtained by the phosgenating a mixture comprising toluene diamines, or the crude diphenylmethane diisocyanate obtained by the phosgenating crude diphenylmethanediamine. Specific examples of such compounds comprise methylene-bridged polyphenylpolyisocyanates, due to their ability to crosslink the polyurethane.

It is often desirable to employ minor amounts of additives in preparing polyisocyanate-based foams. Among these additives comprise one or more members from the group consisting of catalysts, surfactants, flame retardants, preservatives, colorants, antioxidants, reinforcing agents, filler, antistatic agents, among others well known in this art.

Depending upon the composition, a surfactant can be employed to stabilize the foaming reaction mixture while curing. Such surfactants normally comprise a liquid or solid organosilicone compound. The surfactants are employed in amounts sufficient to stabilize the foaming reaction mixture against collapse and to prevent the formation of large, uneven cells. In one embodiment of this invention, about 0.1% to about 5% by weight of surfactant based on the total weight of all foaming ingredients (i.e. blowing agents+active hydrogen-containing compounds+polyisocyanates+additives) are used.

One or more catalysts for the reaction of the active hydrogen-containing compounds, e.g. polyols, with the polyisocyanate may also be employed. While any suitable urethane catalyst may be employed, specific catalyst comprise tertiary amine compounds and organometallic compounds. Exemplary such catalysts are disclosed, for example, in U.S. Pat. No. 5,164,419, which disclosure is incorporated herein by reference. For example, a catalyst for the trimerization of polyisocyanates, such as an alkali metal alkoxide, alkali metal carboxylate, or quaternary amine compound, may also optionally be employed herein. Such catalysts are used in an amount which measurably increases the rate of reaction of the polyisocyanate. Typical amounts of catalysts are about 0.1% to about 5% by weight based on the total weight of all foaming ingredients.

In the process of the invention for making a polyisocyanate-based foam, the active hydrogen-containing compound (e.g. polyol), polyisocyanate and other components are contacted, thoroughly mixed, and permitted to expand and cure into a cellular polymer. The mixing apparatus is not critical, and various conventional types of mixing head and spray apparatus are used. By conventional apparatus is meant apparatus, equipment, and procedures conventionally employed in the preparation of isocyanate-based foams in which conventional isocyanate-based foam blowing agents, such as fluorotrichloromethane (CCl₃F, CFC-11), are employed. Such conventional apparatus are discussed by: H. Boden et al. in chapter 4 of the Polyurethane Handbook, edited by G. Oertel, Hanser Publishers, New York, 1985; a paper by H. Grunbauer et al. titled “Fine Celled CFC-Free Rigid Foam—New Machinery with Low Boiling Blowing Agents” published in Polyurethanes 92 from the Proceedings of the SPI 34th Annual Technical/Marketing Conference, Oct. 21-Oct. 24, 1992, New Orleans, La.; and a paper by M. Taverna et al. titled “Soluble or Insoluble Alternative Blowing Agents? Processing Technologies for Both Alternatives, Presented by the Equipment Manufacturer”, published in Polyurethanes World Congress 1991 from the Proceedings of the SPI/ISOPA Sep. 24-26, 1991, Acropolis, Nice, France. These disclosures are hereby incorporated by reference.

In one embodiment of this invention, a preblend of certain raw materials is prepared prior to reacting the polyisocyanate and active hydrogen-containing components. For example, it is often useful to blend the polyol(s), blowing agent, surfactant(s), catalysts(s) and other components, except for polyisocyanates, and then contact this blend with the polyisocyanate. Alternatively, all the components may be introduced individually to the mixing zone where the polyisocyanate and polyol(s) are contacted. It is also possible to pre-react all or a portion of the polyol(s) with the polyisocyanate to form a prepolymer.

The invention composition and processes are applicable to the production of all kinds of expanded polyurethane foams, including, for example, integral skin, RIM and flexible foams, and in particular rigid closed-cell polymer foams useful in spray insulation, as pour-in-place appliance foams, or as rigid insulating board stock and laminates.

The present invention also relates to the closed-cell polyurethane or polyisocyanurate polymer foams prepared from reaction of effective amounts of the foam-forming composition of this disclosure and a suitable polyisocyanate.

### EXAMPLES

The present disclosure is further defined in the following Examples. It should be understood that these Examples, while indicating preferred embodiments, are given by way of illustration only. From the above discussion and these Examples, one skilled in the art can ascertain the preferred features, and without departing from the spirit and scope thereof, can make various changes and modifications to adapt it to various uses and conditions.

Polyol A is an aromatic polyester polyol (Stepanpol PS2502-A) purchased from STEPAN Inc. at 22W Frontage Road, Northfield, Ill. 60093. Polyol A has viscosity of 3,000 centerpoise at 25° C. The content of hydroxyl groups in Polyol A is equivalent to 240 mg KOH per gram of Polyol A.

Silicon type surfactant is a polysiloxane (Dabco DC193) purchased from Air Products Inc. at 7201 Hamilton Blvd, Allentown Pa. 18195.

Potassium catalyst (Potassium HEX-CEM 977) contains 25 wt % diethylene glycol and 75 wt % potassium 2-ethylhexanoate, and is purchased from OMG Americas Inc. at 127 Public Square, 1500 Key Tower, Cleveland, Ohio 44114.

Tertiary amine catalyst is N,N-dimethylcyclohexylamine purchased from Air Products Inc. at 7201 Hamilton Blvd, Allentown Pa. 18195.

Co-catalyst is 2-methyl(n-methyl amino b-sodium acetate nonyl phenol) purchased from Air Products Inc. at 7201 Hamilton Blvd, Allentown Pa. 18195.

Polymethylene polyphenyl isocyanate (PAPI 580N) is purchased from Dow Chemicals, Inc. at Midland, Mich., 49641-1206.

### Example 1 (Comparative)

In this example, cis-1,1,1,4,4,4-hexafluoro-2-butene was used as blowing agent. Polyol A, surfactant, catalysts, and blowing agent were pre-mixed by hand and then mixed with polyisocyanate. The resulting mixture was poured into a 8″×8″×2.5″ paper box to form the polyurethane foam, and cut to 6″×6″×1.5″ foam samples after 24 hours. The foam sample was kept at 25±2° C. for 28 days and the foam volume was measured again to calculate the volume change. It was found that the volume of the foam had decreased by 66% after 28 days. The formulation and properties of the foam are shown in Tables 1 and 2 below.

TABLE 1
Polyurethane formulation using cis-1,1,1,4,4,4-hexafluoro-2-butene

| Component | Parts by weight |
|---|---|
| Polyol A | 100 |
| Silicon type surfactant | 6.2 |
| Potassium catalyst | 2.8 |
| Tertiary amine catalyst | 0.45 |
| Co-catalyst | 0.8 |
| Cis-1,1,1,4,4,4-hexafluoro-2-butene blowing agent | 30 |
| Polymethylene polyphenyl isocyanate | 78 |

TABLE 2
Polyurethane foam properties

| | |
|---|---|
| Cream time(second) | 9 |
| Rise time (seconds) | 55 |
| Tack free time(seconds) | 55 |
| Foam density (pounds-per-cubic-feet) | 2.51 |
| Volume decrease after 28 days | 66% |

### Example 2 (Prophetic)

The polyurethane foam is made in the same way by using the same formulation as described in Example 1 above, except that 50% of the cis-1,1,1,4,4,4-hexafluoro-2-butene blowing agent is replaced by the trans-1,1,1,4,4,4-hexafluoro-2-butene as a co-blowing agent. It is found that the volume of the resulting foam has decreased by only 15% after 28 days. The polyurethane formulation and properties are shown in Tables 3 and 4 below. By using a foam-forming composition comprising a mixture of trans-1,1,1,4,4,4-hexafluoro-2-butene and cis-1,1,1,4,4,4-hexafluoro-2-butene, the foam shrinkage is reduced from 66% to 15%. Thus, the foam dimensional stability is significantly improved.

TABLE 3
Polyurethane formulation using trans-
and cis-1,1,1,4,4,4-hexafluoro-2-butene

| Component | Parts by weight |
|---|---|
| Polyol A | 100 |
| Silicon type surfactant | 6.2 |
| Potassium catalyst | 2.8 |
| Tertiary amine catalyst | 0.45 |
| Co-catalyst | 0.8 |
| Trans-1,1,1,4,4,4-hexafluoro-2-butene blowing agent | 15 |
| Cis-1,1,1,4,4,4-hexafluoro-2-butene blowing agent | 15 |
| Polymethylene polyphenyl isocyanate | 78 |

TABLE 4
Polyurethane foam properties

| | |
|---|---|
| Cream time(second) | 9 |
| Rise time (seconds) | 55 |
| Tack free time(seconds) | 55 |
| Foam density (pounds-per-cubic-feet) | 2.51 |
| Volume decrease after 28 days | 15% |

What is claimed is:

1. A foam-forming composition comprising trans-1,1,1,4,4,4-hexafluoro-2-butene and an active hydrogen-containing compound having two or more active hydrogens.

2. The foam-forming composition of claim 1 further comprising cis-1,1,1,4,4,4-hexafluoro-2-butene.

3. A closed-cell polyurethane or polyisocyanurate polymer foam prepared from reaction of effective amounts of the foam-forming composition of claim 1 or 2 and a suitable polyisocyanate.

4. A process for producing a closed-cell polyurethane or polyisocyanurate polymer foam comprising: reacting an effective amount of the foam-forming composition of claim 1 or 2 and a suitable polyisocyanate.
